(19) United States
(12) Patent Application Publication
(10) Pub. No.: US 2006/0182000 A1
(43) Pub. Date: Aug. 17, 2006

(54) Multi-dimensional data signal and systems for manipulating the same

(75) Inventor: Robert G. McNiece, Lago Vista, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Lucere, LP

(21) Appl. No.: 11/057,553

(22) Filed: Feb. 14, 2005

(51) Int. Cl. G11B 7/135

(52) U.S. Cl. 369/112.1

(57) ABSTRACT

A device for retrieving multidimensional data from a data storage medium is provided. The device (103) comprises a source of electromagnetic radiation, an optical data processing system (401) adapted to perform logical operations on an input optical data array, and an optical device or devices (125) adapted to direct electromagnetic radiation onto the surface of a data storage medium and to transmit reflections of the electromagnetic radiation, in the form of multidimensional data patterns, to said optical data processing system. The data may be formatted in multiple dimensions.

### CROSS-REFERENCE TO RELATED APPLICATIONS

This application claims priority to U.S. Ser. No. 10/844,739, filed on May 13, 2004 and entitled “Virtual Head for Generating a Multi-Dimensional Data Signal,” having the same inventors, and incorporated herein by reference in its entirety; and to U.S. Ser. No. 10/731,784, filed Dec. 9, 2003, entitled “Apparatus for Generating a Multi-Dimensional Binary Data Signal,” having the same inventors, and incorporated herein by reference in its entirety.

### TECHNICAL FIELD OF THE INVENTION

The teachings disclosed herein relate generally to formatting, processing, transmitting and encryption methodologies, and more particularly to devices and methodologies for generating, storing, retrieving, and manipulating multi-dimensional data signals.

### BACKGROUND OF THE INVENTION

Data storage devices are an essential element of any computer system. These devices have evolved to the point where enormous amounts of data may be stored on these devices and retrieved as needed.

FIG. 1 depicts the functional configuration of a conventional static storage device. The device 11 employs a mechanical head 13 that uses monochromatic radiation 15 to transfer static information from or to a location on a storage medium 17. To gain access to any given data, this mechanical head must traverse along a path defined with respect to the radius and length of the surface of the medium, seeking out the location of the recorded information desired. The time required for this mechanical device to traverse from one location on the storage medium to the next is referred to as “seek time”.

A signal is generated from static data off the surface of the storage medium 17 in linear, sequential fashion with the aid of the mechanical head 13. This signal is then transmitted for the purpose of being acted upon, manipulated by some means, or held in volatile memory.

Information is typically stored in data storage media as binary data. Binary data is typically represented by either a zero or a one, and is known as a bit. Data of this type may be either static or dynamic. Data which resides in a volatile state and which is being processed, transmitted, or otherwise acted upon, such as the data residing in Random Access Memory (RAM), is often referred to as dynamic data. By contrast, data which resides in a non-volatile state, such as the data residing on magnetic tape, magnetic disks, optical disks, and other such non-volatile media, is often referred to as static data.

Structured data, or information, is transmitted from one point to another as data signals. These binary data signals, which typically take the form of energy pulses, are generated for the purpose of storing, retrieving, processing, and transmitting information in the form of bits, bytes, words, packets, and the like. These signals (also called bit streams) are bit patterns that are structured sequentially, that is, structured linearly in one dimension. Hence, an energy pulse may be used to represent a bit of data within a bit stream that can be interpreted as logical lexicons such as “on or off”, “yes or no”, “0 or 1”, “true or false”, or any other type of discreet Boolean expression. Parallel bit streams are multiple sequential bit patterns that require independent channeling per bit stream. Nonetheless, the signal generated is structured linearly and in one dimension. For example, an eight-bit word is based on two discreet binary states to the power of three (2³). The maximum number of unique combinations or states in such a word is eight, and each of those eight binary structures would be represented as some combination of these binary states in sequence. A simple method to represent this value would be to generate three energy pulses in a sequence within a specified time with each pulse being in one of two distinct states. The signal is represented dimensionally as eight possible combinations and each energy pulse is in either of two discrete Boolean states as noted above.

Conventional CD disks of the type presently available have about 3.52 inches of active area. In this area, there are about 20 thousand concentric circular tracks (about 16000 tracks per inch). The tracks in a conventional optical disk are similar to the grooves in a vinyl record in that a single long line contains all of the active information. Each track is about 0.6 micron wide, and the distance between tracks is about 1.6 micron. Data from the spiral track is in the form of depressions, called “pits”, and flat areas, called “lands”. To extract information from an optical disk, a laser is focused through a set of optics onto the tracks. The light reflected from the track will determine if the incident light has landed on a pit or a land. In particular, a pit will disperse the incident light almost completely, while a land will reflect light back. The incident light is passed through a one way mirror disposed at an angle to the incident beam so that light reflected from the track surface will be redirected towards a set of photodiodes for sensing and tracking.

Binary data passing within the area illuminated by the laser is accessed sequentially as the medium rotates, and a signal is subsequently generated which comprises logical, sequential bits that are to be interpreted. This reflected signal, containing the desired binary information, is collected linearly (that is, in one dimension). An electro-optic device mounted on the mechanical mechanism follows this track until the task of accessing the end of the desired recorded information is achieved, a process which can take several rotations of the medium to complete. Once the correct information has been located from the medium, conventional optical devices increase the rotational speed of the medium in order to access the data faster.

The time it takes to acquire the recorded static information from the surface of the medium is referred to as “access time”, and is a function of the rotational speed of the medium and of the electro-optics employed. When multiple requests to the same device occur, the time required for one process to complete before the next request can commence is known as the “lag time.”

Presently, the primary limitation in information retrieval speeds of conventional optical disk drives is seek time. This limitation is the principle reason why data transfer rates do not increase linearly as a function of disk rotation speed. In fact, tests have shown that the 24× optical disks currently available exhibit an improvement in operating performance of only about 20% when compared to 12 optical disks, rather than the approximately 100% improvement that might be expected if seek time were not a factor. The primary reason for slow seek times arises from conventional optical disk drive technology. While current optical disk drives are simple in design and construction, their performance is severely limited by the spatial distance the drive head has to cover, using a motor and gear mechanism, in order to access data located over several different tracks.

Another factor that reduces data retrieval speeds arises when multiple requests for data are sent to a single device. The submission of multiple requests has the effect of increasing the lag time and creating a bottleneck. Unfortunately, any decrease in data retrieval speeds can result in significant performance degradation in equipment which relies for its operation on the data retrieved from the data storage device. Typically, increasing the rotational speed of the data storage medium will not, by itself, compensate for increases in seek times and lag times.

Some attempts have been made to improve information retrieval speeds by constructing optical disk drives which utilize multiple mechanical devices or electro-optic heads to access multiple recorded informational areas. However, the additional cost in parts and electronic overhead makes this approach cost prohibitive for most applications. Other devices are provided with “look-ahead” algorithms to achieve some level of parallel accessing. However, the performance increases achievable with these devices are only incremental, and therefore do not adequately address the above noted problems.

There is thus a need in the art for methodologies for maximizing the performance and minimizing the seek time, access time, and lag time of optical disk drives and other memory devices. There is also a need in the art for memory devices which utilize such methodologies. These and other needs are met by the methodologies and devices disclosed herein and hereinafter described.

### SUMMARY OF THE INVENTION

In one aspect, a device is provided for retrieving data from a data storage medium or media. The device comprises a source of electromagnetic radiation, such as, for example, a monochromatic or polychromatic laser, and a holographic lens element which is adapted to generate a hologram in the form of a multidimensional data pattern. The multidimensional data pattern may comprise, for example, a plurality of line patterns. The device is adapted to direct the electromagnetic radiation onto the surface of a data storage medium and to transmit reflections of the electromagnetic radiation, in the form of multidimensional data patterns, to a detector. The device may further comprise a mirror, which may be a one-way mirror, and the holographic lens element may be adapted to cooperate with the mirror so as to generate a hologram in the form of a multidimensional data pattern. The device may also comprise a sensor array, and the holographic lens element may be adapted to cooperate with the mirror so as to generate a hologram in the form of a multidimensional data pattern that is focused upon the sensor array.

In some embodiments, the holographic lens element is adapted to receive electromagnetic radiation reflected from the data storage medium and is further adapted to generate, from the reflected electromagnetic radiation, a hologram in the form of a multidimensional data pattern that is focused upon said sensor array. In other embodiments, the holographic lens element is adapted to receive electromagnetic radiation from the electromagnetic radiation source and is further adapted to generate, from the electromagnetic radiation, a hologram in the form of a multidimensional data pattern that is focused upon the data storage medium.

Preferably, the data storage medium comprises a plurality of tracks, and the multidimensional data pattern comprises a plurality of line patterns, each of which corresponds to electromagnetic radiation reflected from one of said plurality of tracks. Even more preferably, the data storage medium is an optical disk.

The holographic lens element may comprise a beam splitter. The holographic lens element may be a sinusoidal line generating diffraction grating holographic lens element. It may also be a binary phase beam splitting diffraction grating holographic lens element.

In another aspect, a method for accessing data from a data storage device is provided. The method comprises the steps of directing electromagnetic radiation onto the surface of the data storage medium/media, and receiving, as a multi-dimensional data stream, simultaneous reflections in parallel from multiple tracks of the electromagnetic radiation from the storage medium/media. This reflection can encompass a single land/pit or multiple lands/pits from a single track.

In some embodiments, prior to being directed onto the surface of the data storage device, the electromagnetic radiation is transformed into a hologram comprising a series of patterns. This hologram may encompass, but is not limited to, lines, dots, or combinations thereof. This transformation may be achieved, for example, by a holographic lens element, and the reflection of the hologram may be captured by a CMOS or CCD photo diode array or by other suitable detectors. However, one skilled in the art will appreciate that other linear detector arrays or ensuing technologies may also be used for this purpose, and there use is contemplated herein.

In other embodiments, the reflected electromagnetic radiation may or may not be transformed into a hologram comprising a series of line patterns after being directed onto the surface of the data storage device, after which the reflection of the hologram may be captured by a CMOS or CCD photo diode array.

The multidimensional data stream preferably comprises binary data. In some embodiments, the data storage device, which is preferably a static storage device, may comprise at least first and second data storage media, and a plurality of data tracks may be accessed on the first and second storage media simultaneously and in parallel.

In another aspect, a method for generating a multidimensional data signal is provided. The method comprises the steps of generating a first signal from an electromagnetic radiation source, directing the first signal onto the surface of a data storage device, and receiving a second, multi-dimensional signal from the data storage device. The data captured is preferably binary data.

The method may further comprise the step of manipulating the second signal into at least two combinations of measurable parameters selected from the group consisting of, but not limited to, length, width, height, radius, angle, spatial dimensions, and time. The method may also comprise the step of measuring the second signal. The data storage device preferably comprises at least one static storage medium, and the first signal preferably bisects the at least one static storage medium. The at least one static storage medium may comprise first and second static storage media, and the method may further comprise the step of accessing multiple data tracks on the first and second storage media simultaneously and in parallel.

In yet another aspect, a data retrieval system is provided which comprises a data storage medium, a sensor array, a mirror, and a holographic lens element adapted to cooperate with said mirror so as to generate a hologram in the form of multiple data patterns that are focused upon said sensor array.

In some embodiments, the holographic lens element is adapted to receive electromagnetic radiation reflected from said data storage medium or media and is further adapted to generate, from the reflected electromagnetic radiation, a hologram in the form of multiple data patterns that are focused upon said sensor array.

In other embodiments, the system further comprises a source of electromagnetic radiation, such as a monochromatic or polychromatic laser source, and the holographic lens element is adapted to receive electromagnetic radiation from said source and is further adapted to generate, from the electromagnetic radiation, a hologram in the form of multiple data patterns that are focused upon said data storage medium. Preferably, the data patterns are line patterns, the data storage medium comprises a plurality of tracks, and each of the data patterns corresponds to electromagnetic radiation reflected from one of said plurality of tracks. In some embodiments, the bit patterns on the surface of the disk or storage medium may be multidimensional bit patterns. The storage medium may be preformatted in a multidimensional format (the header files may also be in this format). Either or both of the input and output signals in the system may also be multidimensional.

The data retrieval system may further comprise a source of coherent electromagnetic radiation, and a beam splitter which is adapted to receive electromagnetic radiation from the source and is further adapted to split the electromagnetic radiation into a plurality of multiple beams. The data storage medium may comprise a plurality of optical disks, and the data retrieval system may be constructed such that each of the plurality of beams impinges upon one of the plurality of optical disks.

In still another aspect, a device is provided which comprises a source of an electromagnetic radiation signal, a reflective element adapted to direct the electromagnetic radiation signal onto the surface of a data storage device, a second element adapted to capture binary data in multiple dimensions from the data storage device, medium, or media, transporting means for transporting data in multiple dimensions, manipulating means for manipulating said electromagnetic radiation into any given minimum two combinations of measurable dimensions relating to length, width, height, radius, angle, spatial dimensions, or time, and measuring means for measuring said electromagnetic energy. The data storage device may comprise a static or dynamic storage medium or media. In some embodiments, the data storage device can be adapted to simultaneously read to and write from the data storage medium or media.

In another aspect, a device for generating a multidimensional signal is provided. The device comprises a source of electromagnetic radiation, capturing means for capturing binary data in multiple dimensions from a static storage device, medium, or media, transporting means for transporting data in multiple dimensions, manipulating means for manipulating said electromagnetic radiation into any given minimum two combinations of measurable dimensions relating to length, width, height, radius, or angle, and measuring means for measuring said electromagnetic energy. The signal is preferably convertible to a static state and a dynamic state, and can preferably be measured dimensionally by a function of binary data, by some function of binary bit(s) in relation to time, or by some function of binary bit(s) in relation to space or any combination thereof. The signal may also comprise and be measured by any given number of bits of information in relation to combinations of space and time, or may be manipulated or processed mathematically with linear or non-linear, parallel, or multidimensional algorithms.

One skilled in the art will appreciate that the storing, retrieving, processing, and transmitting of a multidimensional data signal has substantial benefits and can offer significant performance improvements in devices that access data from optical media. Accordingly, the present disclosure provides a means of increasing data at any given time, lowering costs in generating information, decreasing or eliminating input/output bottlenecks, improving static and dynamic data functionality in performance (typically by orders of magnitude), providing a greater level of security for information, and providing a greater degree of data integrity. Still further advantages of the devices and methodologies disclosed herein will become apparent from a consideration of the ensuing description and accompanying drawings.

In yet another aspect, a method is provided herein which comprises (a) providing a source of electromagnetic radiation, (b) directing the electromagnetic radiation onto the surface of a data storage device, (c) converting the reflections from the data storage device into a multidimensional signal, and (d) operating on the multidimensional signal using a complex operator based on the generalized number system N+. The complex operator may be, for example, a Fourier transform or an optical filter, and the multidimensional signal may contain image data.

In still another aspect, a device is provided herein which comprises (a) a source of electromagnetic radiation, (b) a multilayer data storage device having at least first and second layers in which data is stored, (c) a first optical element adapted to direct electromagnetic radiation emitted by the source of electromagnetic radiation onto the surfaces of said first and second layers, and (d) a second optical element adapted to transform reflections of the electromagnetic radiation from said first and second layers into a multidimensional optical signal. The multidimensional optical signal may be encoded with data from said first and second layers. In particular, in some embodiments, each of said first and second layers has a plurality of tracks thereon in which data is stored, and the multidimensional optical signal is encoded with data from a plurality of the tracks on said first layer and a plurality of the tracks on said second layer.

In a further aspect, a method for identifying an individual is provided herein. In accordance with the method, a first multidimensional signal is obtained from a first source, said first signal being encoded with image data relating to the anatomical features of individuals whose images are stored in a first database. A second multidimensional signal is also obtained from a second source, said second signal being encoded with image data relating to the anatomical features of individuals whose images are stored in a second database. A third signal is then obtained from a third source, said third signal being encoded with the anatomical features of an individual whose identity is to be ascertained. The data encoded in the third signal is then compared to the data encoded in the first and second signals in an attempt to ascertain the identity of the individual. In one specific application, the first and second databases are distinct databases maintained by separate governmental organizations and/or security agencies, and the third signal is obtained from a camera or other surveillance device that is located at an installation (such as an airport) that is being monitored.

One skilled in the art will appreciate that the various aspects of the present disclosure may be used in various combinations and sub-combinations, and each of those combinations and sub-combinations is to be treated as if specifically set forth herein.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 is an illustration of a conventional data storage device;

FIG. 2 is a ray tracing showing a generated source of coherent electromagnetic radiated energy interacting with a mirror component (the mirror component inverts the electromagnetic radiated energy) and bisecting perpendicularly two optical disks;

FIG. 3 is an illustration depicting the reflected energy source of FIG. 2 from a multifaceted mirror component or passing through a Holographic Optical Element (HOE) and striking a detector with the data pattern captured from the media in a recognizable pattern;

FIG. 4 is an illustration showing the illumination of multiple data tracks on a storage medium upon an imager;

FIG. 5 is an illustration of one specific embodiment of a data retrieval system made in accordance with the teachings herein;

FIG. 6 is an illustration of a line pattern generated by a line generating holographic element;

FIG. 7 is an illustration of line pattern incidence on an optical disk;

FIG. 8 is a 3D cross section of a generic multidimensional binary data signal;

FIGS. 9-14 are schematic illustrations of a system for operating on data in the optical regime;

FIG. 15 is an illustration of a multidimensional signal; and

FIG. 16 is a 3-D multilayer optical memory device that may be used in the devices and methodologies described herein.

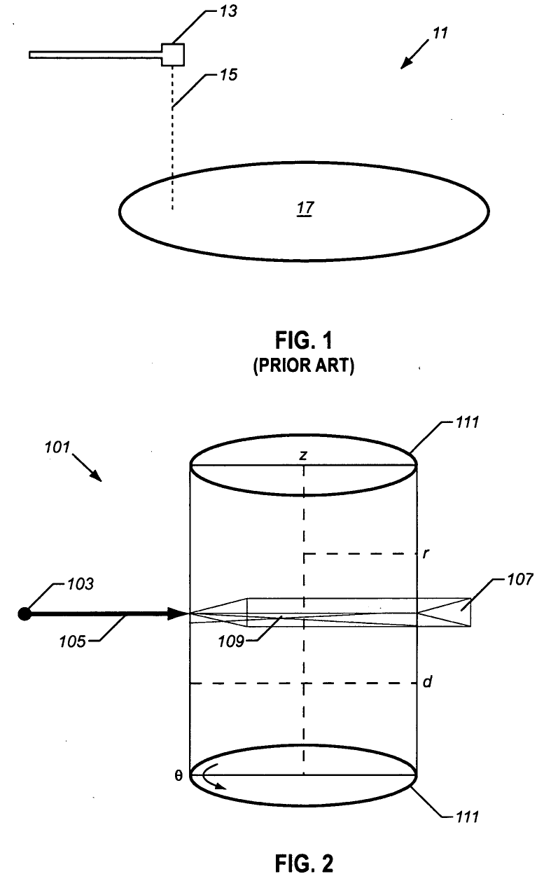

### DETAILED DESCRIPTION OF THE INVENTION

A. Overview

In accordance with the teachings herein, methodologies and devices are provided that maximize the performance and minimize the seek time, access time, and lag time of optical disk drives and other memory devices. In particular, a novel disk drive design is provided herein which eliminates moving parts from the drive head and which increases data transfer rates by several orders of magnitude. Various methods which utilize, or which may be implemented by or used in conjunction with, this disk drive design are also disclosed.

In some embodiments of the disk drive design disclosed herein, the drive accesses data simultaneously from several tracks or locations on one or more optical disks or other optical data storage medium, thus eliminating or greatly reducing seek times. This design enables multidimensional data access, wherein burst reads can make data transfers within a single signal from several tracks simultaneously, in parallel, wherein single and/or multiple bits per track can be illuminated with the read head, and wherein the principle limitation in data access rates is the processing electronics. The methodologies and devices disclosed herein maximize the performance of data storage units and the devices that utilize them, and may be used to minimize or eliminate seek time, access time, and lag time in such devices.

Methodologies and devices are also disclosed herein which utilize multidimensional signals to store, retrieve, process, and transmit information and its components. By contrast, conventional telecommunications, network infrastructures, and digital environments typically store, transfer, and manipulate bits of information in one dimensional, linear terms.

The novel disk drives disclosed herein allow data to be available instantaneously or simultaneously from static storage media. Consequently, seek time and lag time are essentially eliminated, while access speeds are limited only by the latency (that is, the time it takes for a specific block of data on a data track to rotate around to the read/write head) of the media. The resultant signal that is generated from the modified device is multidimensional and hence has a more complex structure than the signals generated in conventional data storage technologies. This multidimensional signal may be transmitted and/or manipulated in a variety of ways. Furthermore, a signal of this type enables the use of multidimensional formatted media or matrices for storing, retrieving, processing, and transmitting data relative to a given task and state of the data.

The above noted means for accessing any and/or all tracks of the medium at any given time preferably includes a signal source referred to herein as a Virtual Head (VH). When the signal source is a source of electromagnetic radiation, the VH may be referred to as a “Virtual Optical Head” (VOH). It will be appreciated, of course, that various signal sources can be used in the devices and methodologies described herein, including, but not limited to, acoustic, microwave, short or long wavelength radio, or x-ray signal sources.

In order to generate the complex signal, the VH bisects the diagonal or radius of the data storage media at some given distance perpendicular, or near perpendicular, to the media surface, thus allowing all data to be accessed in one half to one rotation of the media. The return signal is a multidimensional signal comprising binary data that can boost system performance by several orders of magnitude compared to conventional data storage devices.

When the virtual head is applied to a single medium, the format is commonly a two dimensional signal generated over time, but the signal could also have 3 or more dimensions. If N multiple media are utilized, a signal having N or greater dimensions can be generated over time. The mathematical difference between the information conveyable using conventional one-dimensional technology, and that conveyable using a multi-dimensional approach of the type disclosed herein, can be appreciated with reference to TABLE 1, which shows a comparison of the possible unique permutations for an n-dimensional eight-bit data array or “word” based on 2 discreet binary states, wherein all dimensions have a maximum equivalent value and time t is constant:

TABLE 1
Possible Permutations in n-Dimensional Words

| Dimensions | Permutations |
|---|---|
| 1 | 64 |
| 2 | 4096 |
| 3 | 262144 |

The details of some aspects of the devices and methodologies used to implement this approach are described in greater detail below and with respect to the specific, non-limiting embodiments depicted in the figures.

FIG. 2 illustrates one particular embodiment of a data storage device made in accordance with the teachings herein. The data storage device 101 comprises a source 103 of coherent electromagnetic radiation 105. As noted above, the source may be a component of the virtual optical head. The electromagnetic radiation generated by this source may be referred to as the transmission signal, and can be characterized by various quantitative features, such as, for example, wavelength, frequency, power, and geometrical spatial distribution.

The electromagnetic radiation from the source is shown interacting with a mirror component 107. The ray tracing shows the direction of the initial transmitting signal inverted vertically in the z direction, with width x of the original signal divided over a given length xy 109. Since the width of the original generated signal is now the length of xy, the electromagnetic radiation bisects perpendicularly the diagonal (equal to d or xy) of the static storage media 111 which, in the particular embodiment depicted, comprises two optical disks.

The mirror component is preferably adapted to reflect the electromagnetic radiation at two times the angle of incidence, and to elongate the electromagnetic radiation by some given length xy. The length xy is preferably a minimum of the radius or diagonal of the optical disk or other storage media. In some embodiments, positive and negative vertical values may be created simultaneously with this component.

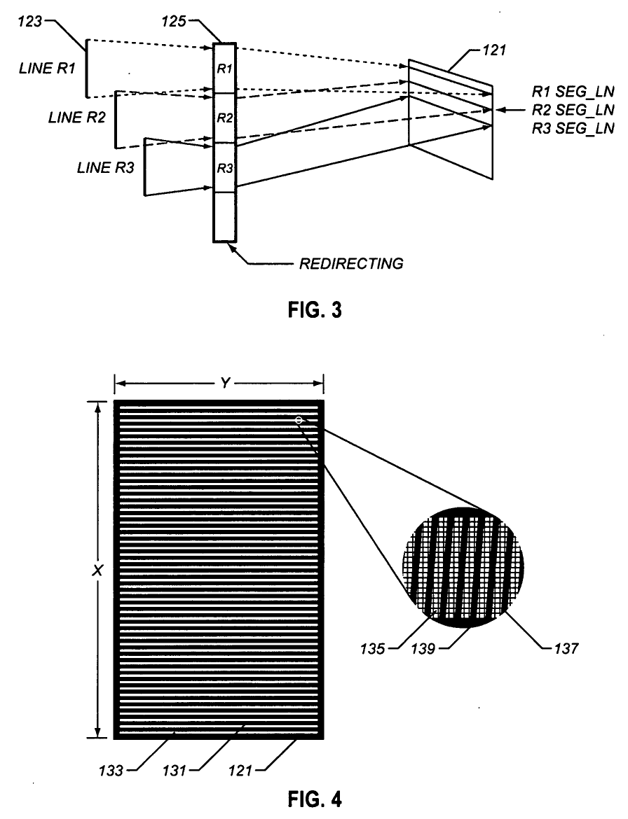

As previously noted, the electromagnetic radiation strikes and illuminates the optical disks 111 (which contain static data) perpendicularly or near perpendicularly, bisecting the radius/radii or diagonal/diagonals over given special domains measured in two/three dimensions, respectably. This illuminated space of coherent, electromagnetic energy captures data stored on the surface of the optical media and reflects it back according to the angle of incidence. This multidimensional, reflected signal passes through a hologram for the purpose of segmenting the signal. This segmented, multidimensional, coherent electromagnetic energy may be imaged on a detector 121 or sensor as shown in FIG. 3. The detector may be, for example, a CCD or CMOS detector. Other components may be employed for optimal focusing, alignment, and other purposes.

FIG. 3 shows the return signal (second signal) reflected from the optical disk by way of mirror component 107 of FIG. 2. The reflected signal is now a Multidimensional Data Signal (MDS) 123 which passes through a Holographic Optical Element (HOE) or multifaceted, segmented mirror component 125 prior to striking the detector 121. The second signal is now segmented and aligned upon a sensor array. When the MDS impinges upon the detector, it is encoded with the data pattern captured from the data storage media 111 (see FIG. 2) in some recognizable pattern.

FIG. 4 is an illustration of a magnified perspective of the reflected signal imaged upon the detector 121. The segmented reflected radiation (second signal) is measured dimensionally by the Cartesian coordinates (xy). The radiation illuminates the static data stored on the surface of the data storage media and captures simultaneously multiple data tracks, and can capture single or multiple binary bits of data. The amount of data captured may be measured in terms of the number of bits of data within the mathematical domain {x, y; r, θ}. As illustrated in FIG. 4, MDS light areas 133 represent the reflected signal segmented upon the imager, while the dark areas 131 represent separations between segmentations of the second signal. In a magnified perspective 139 shown to the right, each of the light areas 133 contains multiple data tracks 135 while the dark areas 137 indicate the adjacent lines or dead space” between tracks. When multiple disks are illuminated, the amount of data captured may be represented mathematically, in some instances, by the three-dimensional domain {x, y, z; z, r, θ}.

In the preferred embodiment, a source of electromagnetic radiation, which is preferably a laser, is used to generate the signal that perpendicularly bisects the optical disks or other static data storage media, thereby resulting in multiple data tracks being accessed simultaneously, at the speed of light, and in parallel. This aspect of multidimensional signal generation can be achieved either through holographic means or by way of a properly designed mirror component. This signal source of electromagnetic radiation captures binary data in multiple dimensions from the surface of the medium (media) and returns this pattern by reflection. The reflected MDS can be transmitted through space and/or inverted to accommodate transmission via optical fiber, by microwave transmission, through acoustic transmission, or through other suitable means, and can be captured on a Charged Couple Device (CCD), a CMOS detector array, or by other suitable means.

The signal which bisects the optical disk(s) or other static data storage media can be of a variety of geometrical patterns and can be of variable width, height, length, and intensity. The signal can be pulsed, quasi-pulsed, modulated or continuous, and be generated in any frequency of the electromagnetic spectrum. The return, reflected, multidimensional binary signal will vary with binary data as the media rotates over time. The static medium or media can be horizontal, vertical, or any degree off axis and can rotate at a set, variable or any combination of speeds. The data on the static media can be stored in a linear or multidimensional format. The MDS can be processed or manipulated linearly or multi-dimensionally with the appropriate algorithms. Notably, the MDS can be treated with current, linear means resulting in linear computations.

B. Novel Disk Drive Design

1. Overview

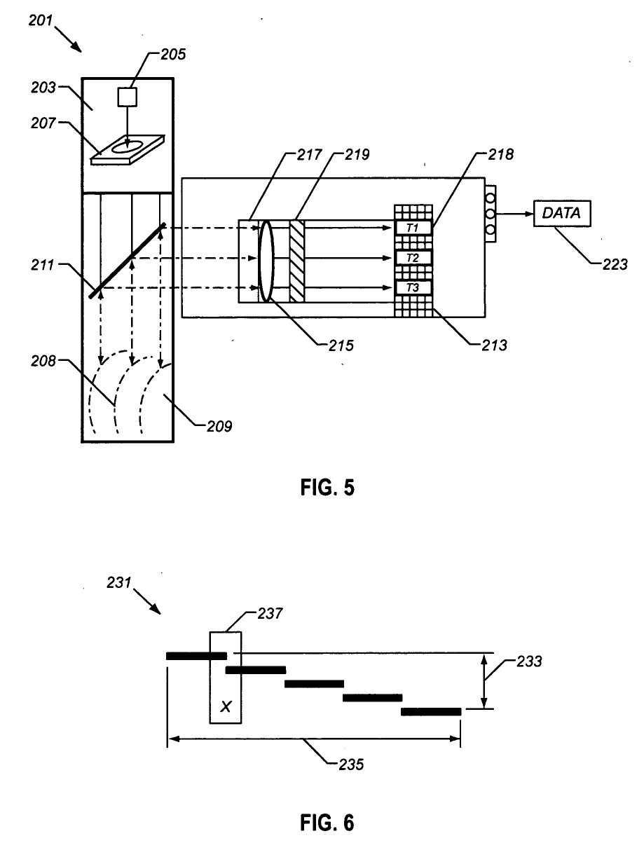

FIG. 5 illustrates another embodiment of a disk drive of the type disclosed herein. The disk drive 201 comprises a holographic line generating unit 203 that comprises a monochromatic or polychromatic laser source 205 and a holographic optical element 207. The holographic optical element 207 transforms the radiation from the laser source into a hologram in the form of multiple line patterns that impinge upon the data tracks 208 of the optical data storage medium 209. A one-way mirror component 211 is provided that redirects reflections from the optical data storage medium through a set off focusing optics 215, 217 and a redirecting mirror 219 and onto a detector array 213. The reflections 221 of the data tracks 208 from the optical storage media 209 are thus read by the detector.

The holographic lens element is preferably a sinusoidal line generating and/or binary phase beam splitting, diffraction grating holographic lens element. Such lens elements are available commercially from a variety of merchants. The hologram generated by these devices is a predefined image that has specific dimensions given as coordinates (x,y) which can be measured and quantified.

The disk drives disclosed herein may have one of at least two possible designs. In the first design, the line pattern or “beam” passes along an optical path including a one-way mirror before reaching the optical medium or media. Then, the holographic pattern is generated after reflecting off of the surface of the optical medium or media.

In some embodiments, a first set of focusing optics is provided to shape and size the line pattern as required by the geometry of the optical medium or media or detector. After incidence on the optical medium or media, the beam reflects and travels back the same path, or off axis a degree or so, towards a one-way mirror and passes through a holographic optical element, which segments the single line into multiple lines. The one-way mirror redirects the returning reflected signal that comes from the optical medium to a detector. A second set of focusing optics along with a redirecting mirror serve the function of spreading the beam over the sensor space of the detector as required by the sensor geometry and in such a way that the reflections of the data tracks from the data storage media are impinged upon the detector. The detector may be a CMOS or CCD detector array or the like and is preferably capable of random pixel selection with on board A-D conversion and onboard clocking.

2. Holographic Line Generating Element

The holographic line-generating element 207 is an important component of many of the disk drives and other data storage and retrieval systems disclosed herein. Line generating devices that are currently commercially available generate up to 99 lines. These translucent lenses, for the purpose of discussion relative to this subject matter, create either 1-D linear incident patterns, or a 2-D plane of equidistant incident holographic pattern, which can then be focused down to a focal plane. If the incident beam is elliptical (as with diode lasers), elliptical patterns will emerge.

Dynamically, the reflected or incident beam of the laser emerges from the HOE as a hologram divided and diverging at consistent degrees of uniformity. This holographic pattern, when focused on the surface of an optical disk or detector, provides a homogenous environment for bit pattern recognition along the disk's radius. When the data storage media comprises a plurality of stacked optical disks and this hologram is utilized, the distances between the stacked disks can be very small (e.g., on the order of 1 to 3 mm), thereby simplifying complex alignments between different optical constituents. The length of the line, the pattern required, and the number of lines is determined by the geometry of the optical disk(s) and the sensor array. Some possible line patterns that can be used are shown in FIGS. 3 and 6.

With reference specifically to FIG. 6, the line pattern 231 shown therein comprises a series of lines 232 having an overall beam width 233 and an overall beam length 235. The overall beam length, width and height are variable but the beam length is preferably equal to at least the radius or diagonal of the optical disk(s). With respect to the sensor array, the length of the line may be dependent on the sensor geometry, and this factor will determine the total number of lines needed. Preferably, two adjacent lines should overlap each other (the area 237 marked X) to obtain coverage of all the lines in the optical disk(s) and to provide redundancy for error correction.

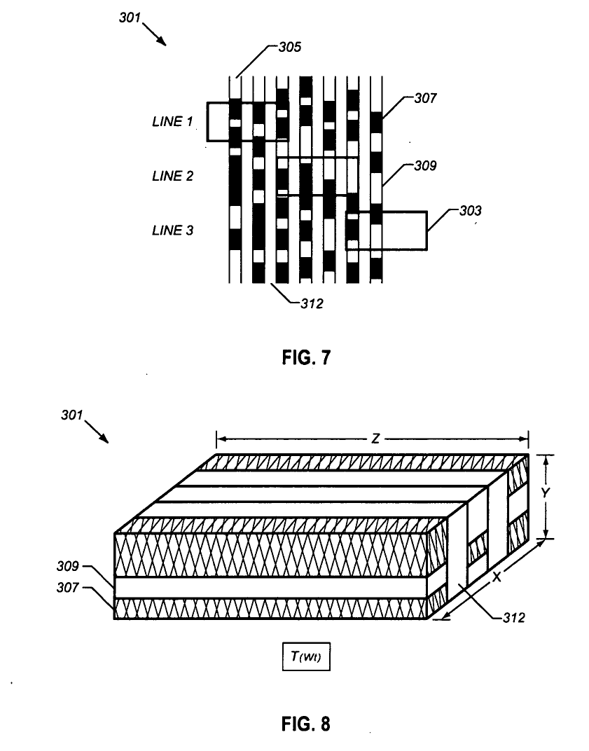

The reason for this type of pattern can be appreciated with respect to FIGS. 7 and 8. FIG. 7 depicts one of many line patterns 301 incidence on an optical disk. The rectangles 303 represent segments that perpendicularly bisects the radius of the optical disk(s) and intersects its tracks. Each track 305 comprises a plurality of dark boxes 307 and white boxes 309. The dark boxes 307 indicate pits in the tracks of the optical disk(s), while the white boxes 309 represent lands. The spaces 312 between adjacent lines correspond to spaces between the tracks in the optical disk. Since the recorded area has finite dimension, multiple pits and lands are captured. The recognized bit pattern is the result of flux intensities reflected from the disk surface(s) captured within this focal plane or volume which then will be imaged and resolved on the sensor array. Since a pit disperses the incident light and the land reflects it back completely, the reflected beam is a two dimensional image of the area of incidence 303. FIG. 8 is a 3D cross section of Line 1 of FIG. 7 at incidence T(wₜ), where T is a function of the energy (E) delivered from the laser measured in Watts over a given time “t” measured in micro to nano seconds.

3. Distribution of Power & Loss with Signal to Noise Ratio

The laser signal by definition will lose power at each interface within the system, including the interfaces at such components as the hologram, the mirror or lens components, and the disk(s) surface. Theoretically, considering power distribution over a given area will give a general understanding of the signal and its loss function ξ(x,y,z). In a typical, non-limiting set-up, the loss function is given by the integral:
ξ(x,y,z)=[P−∫∫∫Hdxdydz−∫∫∫Ldxdydz−∫∫∫D(R sin θ)dθdxdy] [EQUATION I]
wherein

ξ=loss;

P=initial laser power;

H=reflection loss at hologram;

L=scattering loss at any lens element;

D=scattering loss at the disk(s); and

R sin θ=area covered by the focal plane.

It is important to note that this system is dealing with a volume of light (and hence the 3 dimensional integrals) until it strikes the disk(s). At that point, the dependence is brought down to an area with changing dθ.

The Signal to Noise Ratio (SNR) of a theoretical system is given by EQUATION 2 (representative, non-limiting values for some of the parameters in EQUATION 2 and in the succeeding equations and calculations have been provided for purposes of illustration):
SNR=AER [EQUATION 2]
wherein

A=the area of the focus plane=65(0.9 μm×1600 μm);

E=T(wₜ)=(laser power in Watts)(time)=Joules

R=CMOS or CCD sensor array response.

4. Magnifying Optics

The reflected plane is a representation of the cross section of the optical disk(s). Each pit or land is captured as an image within this hologram. This beam will be magnified naturally as a result of the hologram before it impinges on the sensor array. The magnification of the reflected beam, which is accomplished by the nature of the hologram's creation, may be understood in reference to the following non-limiting example.

The distance between two adjacent tracks in some currently available optical disks is 1.6 microns. The track itself is only about 0.6 micron. Using 0.35 micron technology, the smallest pixel size that is currently available in the CMOS or CCD detectors is about 8-9 microns. However, the image size of a pit or a land on an optical disk is typically much smaller. This means an image of many lands and pits will be smaller than the sensor pixel size, thus necessitating magnification of the return beam.

It has been determined that, for signal processing and tracking purposes, each track on the return beam has to cover a pixel space of at least 1×2. It is thus necessary to get coverage of at least 1×2 CMOS pixels (these could also be based on CCD or another technology) per track. It will be appreciated, of course, that optimally, a 1:1 correlation is used (e.g., 1 land to 1 pixel). After the magnification, the beam goes through a second set of lenses for shaping and focusing purposes. A rough calculation indicates that the magnification has to be of the following order:

0.6 micron=track width

9 micron=pixel size

1×2 pixels=>9*2 microns=18 microns (i.e. the length of the 1×2 array).

Therefore, the required magnification is 18/0.6 or about 30×.

5. Redirecting Optics

The purpose of the redirecting optics is to align and focus all the returning lines onto a given CMOS or CCD array geometry. The length of the returning beam is equal to the radius of the optical disk(s). Unfortunately, most sensor arrays cannot cover this area. However, since the returning beam is split into many lines, it is only necessary to have a CMOS or CCD array that is as wide as the length of a hologram. All the adjacent lines can then be redirected below this line on the CMOS or CCD array.

The redirecting optics can be accomplished either by utilizing another HOE, or by utilizing a mirror component with varying reflective indices (e.g., R₁<R₂<R₃<R₄>R₅>R₆, etc.). Due to these varying refractive indices, adjacent lines get focused below each other within the geometry of the CMOS or CCD. Thus, even though the angle of incidence for all the lines on the redirecting mirror is the same, due to the varying reflective indices, the angle of reflection changes. This change takes place where one track ends and the other track begins, as illustrated in FIG. 4.

6. Sensor Array

Another important element in some of the devices made in accordance with the teachings herein is the CMOS or CCD sensor array. The ability of the CMOS or CCD sensor array to pick any pixel in the sensor space within the response time of the detector is critical to the operation of optical drives made in accordance with the teachings herein. Currently, this response time is on the order of microseconds. Since accessing pixels is equivalent to accessing different tracks, optical drives made in accordance with the teachings herein will be able to switch from one track to another at the response time of the CMOS or CCD detector once the driver software has calculated which track to access. It should also be clear that multiple outputs are achievable.

The geometry of the CMOS or CCD will typically drive the other physical design considerations of optical drives made in accordance with the teachings herein. TABLE 2 shows how the array size of the detector determines the number of lines needed from the line generator. Assuming that x represents that longest dimension of the CMOS or CCD detector and that the total number of tracks is 65,000, the number of pixels required per track in the x direction is 1 pixel. Therefore total number of pixels needed in the x direction for all 65,000 tracks is 65,000×1=65,000 pixels.

TABLE 2
Number of Lines Needed From Line Generator
as a Function of Array Size

| | No. of Pixels in the | |
|---|---|---|
| No. | X direction | No. Of lines needed |
| 1 | 1024 | 195 |
| 2 | 1050 | 190 |
| 3 | 2000 | 100 |
| 4 | 2050 | 97 |
| 5 | 3000 | 66 |
| 6 | 3050 | 65 |
| 7 | 4000 | 50 |
| 8 | 4050 | 49 |

Table 2 shows that an optimum pixel size would be 3000 or 4000 pixels in the x direction. The choice of array for a particular application would depend upon such factors as the response time, signal processing capabilities, and geometry of the array. The values set forth in TABLE 2, and the subsequent calculations based on these values, are for illustrative purpose only and assume a 10 micron technology. One skilled in the are will appreciate that these numbers may change as the detector array technology evolves.

For the y direction, the number of pixels needed can be calculated as follows:
required magnification=45×
line width=9 microns
number of lines=65 for 3000 pixels in the x direction
number of lines=50 for 4000 pixels in the y direction
Therefore, total width=20 (width)*(66 or 50) lines*45 (mag.)=59,400 microns or 45,000 microns. Assuming a pixel size of 10 microns and an inter pixel distance of 5 microns, the number of pixels in the x direction is
59,400/15 or 45/000/15=4400 pixels or 3000 pixels.
Hence, the array dimensions are 3000×44000 or 4000×3000.

7. Signal Processing

From a processing standpoint, if all the tracks map to a specific pixel space and do not change over time, the mapping of the particular track in the optical disk(s) to a specific pixel space can be predetermined. Once this relationship is known, the mapping can be made an integral part of the software driver.

For purposes of data access, it is only necessary to monitor the pixel that corresponds to the line to be accessed. For accessing data from any track, consider a virtual read head having a 1×2 pixel window. As the optical disk(s) spins, the virtual head remains stationary while accessing, at the speed of light, virtually any or all tracks and/or bit(s) simultaneously and/or in parallel. This is accomplished by slowly incrementing the x-access line of the detector, while keeping the y access line constant until the 1×2 head reaches the edge of the detector. The 1×2 head moves along one of the line images on the CMOS or CCD array. Once the edge of the detector is reached, the y access line is incremented by a known amount to next line image on the CMOS or CCD detector which corresponds to the continuation of a track in the optical disk(s). This is equivalent to the stylus of a record player moving closer to the center of the disk(s) as the disk(s) spins. A similar effect is accomplished here using a Virtual Read Head (VRH).

One significant difference between optical drives made in accordance with the teachings herein and conventional optical disk(s) manifests itself when the drive has to access data from another line many tracks away from the current line. As noted above, a conventional drive would have to calculate the spatial distance to move the head, and then use a gear mechanism to get to that location. In optical drives made in accordance with the teachings herein, the same effect is obtained simply by applying different coordinates to the x and y by the driver software to access lines in the CMOS or CCD detector.

Since the driver software will have the mapping information for all the tracks, the only thing needed is to feed the x and y access lines with the appropriate coordinates for any given track. This makes it possible to start supplying the data almost immediately. The time required to accomplish this task is estimated to be significantly less, or at worst equal, to the time taken by current drives to compute the distance to move the read head. However, in conventional drives, the read has to then move to its required location. Since optical drives made in accordance with the teachings herein can use a VRH, this operation is eliminated.

8. Other Applications

A. Parallel Reads

The novel optical drives disclosed herein enable a variety of other performance boosting mechanisms. For example, using a multi-tap CMOS or CCD detector, it is possible to do data look ahead on several tracks basically “on-line”, that is, accessed concurrently or simultaneously instantaneously, prior to the VRH actually accessing that track. This facilitates burst reads as data from several tracks can be simultaneously fetched and processed in the same time it takes to process one track. The cost of processing many parallel tracks is in the processing electronics, and not in the drive heads themselves.

B. Multiple VRHs

Another function possible with optical drives made in accordance with the teachings herein is multiple, concurrent reads. The optical drives disclosed herein offer the possibility of simultaneous reads at different locations on the optical disk(s). This is equivalent to two users using the same optical disk(s) but accessing different tracks from that optical disk(s), a feat unimaginable with conventional drive technology. The real world advantage is that data requests to the drive from multiple users, to two or more different locations, need not be serialized. Rather, both the requests can be handled simultaneously.

C. Structure of Multi-Dimensional Signal

The multidimensional signals used in the devices and methodologies described herein may take on a number of forms. For purposes of discussion, these signals will be described with reference to a system containing n optical media M₁, . . . , Mn, where n is a nonzero integer, and wherein the medium Mᵢ has kᵢ tracks, it being understood that the multidimensional signals described herein are not limited to such a system. Various optical elements may be used as necessary to collimate and decollimate the signal, to extract particular wavelengths and/or polarizations of radiation from the signal or to combine particular wavelengths and/or polarizations of radiation into a signal, to redirect, reflect or polarize the signal or component wavelengths or beams thereof, to change the polarization of a component of the signal, and to detect the intensity, polarization and/or wavelength of the return signal or a component thereof. These optical elements may or may not include multiplexers, demultiplexers, polarizers, mirrors, holographic lens elements, optical retarders, and other such devices.

In one embodiment, the source of electromagnetic radiation is used to provide a monochromatic input signal, which may be collimated (as through use of a HOE) such that it impinges on all kᵢ tracks of optical medium Mᵢ or on a subset of the kᵢ tracks. The return signal may also be collimated and may be passed to a detector, where all of the collimated beams, or a subset thereof, are passed to a detector or to an array of detectors. In one particular example of such an embodiment, each of the n optical media is associated with a detector having kᵢ elements, where each element senses the return beam associated with a particular track.

In other embodiments, the input electromagnetic radiation is from a polychromatic radiation source, and thus comprises n wavelengths of electromagnetic radiation λ₁, . . . , λₙ, wherein n≧2, and this radiation may be collimated or multiplexed. In a first such embodiment, each mᵢ optical medium is associated with a detector having kᵢ elements, where each element senses the return beam associated with a particular track in the medium, and electromagnetic radiation having a wavelength λᵢ is used to read the tracks of optical medium mᵢ. In a second such embodiment, an optical medium mᵢ is provided which has nᵢ tracks, and electromagnetic radiation having a wavelength λᵢ is used to read track kᵢ, where i=1 to nᵢ. In some variations of this embodiment, each of the mᵢ optical media have the same number of tracks, and electromagnetic radiation having a wavelength λᵢ is used to read track kᵢ of each of the optical media. In any of the aforementioned embodiments, the signal may be operated upon by one or more optical elements, including polarizers, mirrors, and holographic lens elements.

Moreover, the mirror component is wavelength selective, and functions to extract the first wavelength λ₁ for impingement on the first optical storage media, and to extract the second wavelength λ₂ for impingement on the second optical storage media. The electromagnetic radiation of the first and second wavelengths may be collimated prior to impingement so that, for example, one beam of the collimated radiation is directed onto each track in the optical media.

The return signals from the optical storage media may be analyzed separately, or they may be recombined and analyzed as a multiplexed signal. If they are analyzed separately, then two or more detectors may be provided, one for each optical medium. At any instant in time, the signal impinging upon a detector array will be a row or tuple of binary digits, each digit corresponding to the bit encoded on a particular track in the optical media. Hence, if the optical media is a disk having n tracks, and if a bit is encoded on a particular track at an angle θ_{w}, where w is 1 to k, then the signal input across a detector for each rotation of the corresponding disk will be a k×n matrix of binary values.

If the return signals are analyzed as a multiplexed signal, the signal input across the detector for each rotation of the disk will be a 2×k×n matrix. Generalizing to the case of m optical media, the signal input across the detector for each rotation of the disk will be an m×k×n matrix.

The basic structure of one particular, non-limiting example of a multi-dimensional signal of a type that may be utilized in the devices and methodologies described herein is shown, for example, in FIG. 8. This signal structure is created through the use of a monochromatic radiation source. However, in other embodiments, such as the parallel data processing architectures described below, it may be desirable to use a polychromatic radiation source. The multiple wavelengths generated by such a polychromatic radiation source may be further resolvable into orthogonal polarizations.

Such a polychromatic source can be used to enable polarization and wavelength encoding schemes that greatly facilitate parallel processing in conjunction with a multidimensional data signal of the type described herein. In particular, because multiple wavelength light plane arrays may be propagated through the same space without mutual interference, they enable true multidimensional processing.

FIG. 21 illustrates a specific, non-limiting example of a multidimensional data signal of the type described herein. As shown therein, the signal 601 comprises polarization and/or wavelength encoded data. In particular, the data signal comprises multiplexed wavelengths 603, 605 and 607. Each of these wavelengths is encoded in one of two orthogonal polarization states to represent a logical “1” or “0”.

D. Architectures for Parallel Database Processing

As previously noted, in some embodiments of the disk drive design disclosed herein, the drive accesses data simultaneously from several tracks or locations on one or more optical disks or other optical data storage medium, thus eliminating or greatly reducing seek times. This design enables multidimensional data access, wherein burst reads can make data transfers within a single signal from several tracks simultaneously, in parallel, wherein single and/or multiple bits per track can be illuminated with the read head, and wherein the principle limitation in data access rates is the processing electronics.

Since the processing electronics will often be the rate limiting step in the systems described herein, these systems may be further improved by shifting various data processing operations away from the electronic realm and into the optical realm, where they can occur at speeds commensurate with the retrieval speeds of data from optical media as described herein. One method of accomplishing this objective is to utilize an architecture for parallel data processing that permits the bulk of data processing operations to be implemented in the optical regime, where the large degrees of processing freedom associated with electromagnetic radiation can be combined with a parallel, associative model of data processing to achieve extremely high levels of parallel processing. When combined with the devices and methodologies described herein for generating and manipulating multidimensional signals, such an architecture provides unparalleled abilities for processing vast amounts of information at very high speeds.

In particular, such an architecture helps to harness the full potential provided by the ability of a virtual head to read multiple tracks from an optical disk (or from multiple optical disks or devices) by eliminating the bottleneck that might otherwise occur at the optical/electronics interface. Thus, by allowing many common database functions to be implemented in the optical regime, the need to convert complex multidimensional optical signals into electronic signals before processing of the signal commenced can be reduced or eliminated.

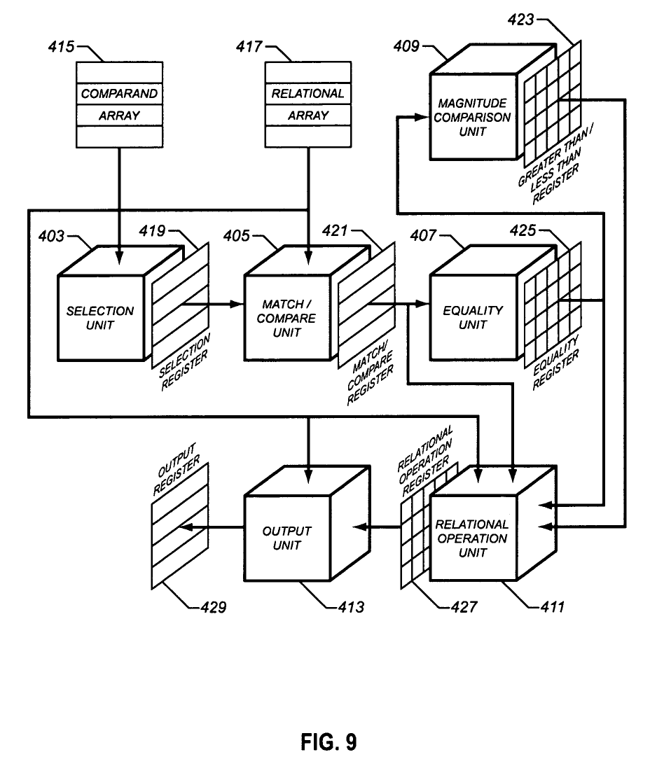

FIG. 9 depicts the overall schematic organization of one possible embodiment of such a system 401. As seen therein, the system includes, as optical modules, a selection unit 403, a match/compare unit 405, an equality unit 407, a magnitude comparison unit 409, a relational operations unit 411, and an output unit 413. These modules may be used to implement a variety of basic database operations, including, but not limited to, difference, intersection, union, product, projection, conditional selection, join, maximum, minimum, division and update. The arrows in the figure signify a 2-dimensional array of optical data, referred to herein as a light plane array.

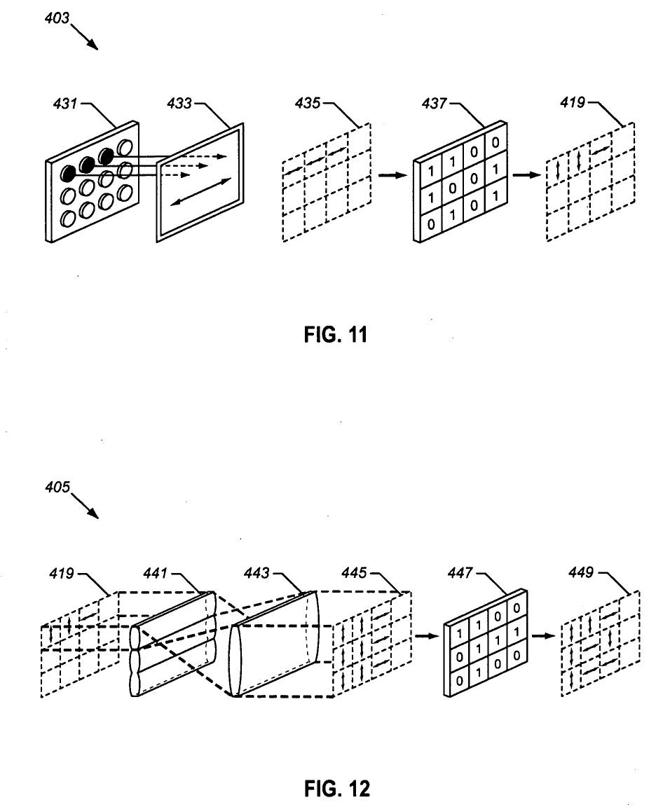

As seen in FIG. 9, the system utilizes, as inputs, a comparand array 415 and a relational array 417. In the specific embodiment depicted, each row (or tuple) of the comparand array 415 and the relational array 417 are polarization logic encoded with different wavelengths of electromagnetic radiation, it being appreciated that various other encoding schemes could also be utilized. This method of encoding is achieved through the use of a multiple wavelength source array in conjunction with a spatial light modulator (see, e.g., FIG. 11 and the discussion pertaining thereto). As explained in greater detail below, the spatial light modulator serves to translate radiation emitted by the source array (and subsequently polarized) into a wave front in which the polarization state of a given element in the comparand array 415 or in the relational array 417 is representative of the logical state (i.e., “0” or “1”) of a data bit on the optical media in which the underlying data resides. This may be accomplished, for example, by utilizing an optical element which translates the pits and lands of a track on an optical medium into light pulses of a first and second polarization, respectively. This method of encoding permits multiplexing by allowing the superposition and parallel processing of multiple comparands as they propagate through the match/compare 405 and/or equality 407 units. Thus, this method of encoding represents one or more means by which the complex multidimensional signals described herein which are generated from multiple tracks and/or multiple bits of one or more optical media may be processed.

With further reference to FIG. 9, the selection unit 403 produces the selection register 419, which is a light plane array that holds the multiple tuples in the comparand array 415 that are to be matched. The optical match/compare unit 405 produces the match/compare register 421, which is a wavelength/polarization encoded light plane array that holds the locations of all the matched and mismatched bits. The optical magnitude comparison unit 409 inputs the comparand array 415 and the relational array 417, performs a magnitude comparison (greater than/less than) operation on pairs of comparand array and relational array tuples, and outputs less than and greater than registers 423. The optical equality unit inputs the match/compare register 421 and outputs the equality register 425, which is a light plane array that represents the intersection locations of the comparand array and relational array tuples.

The light plane arrays of the equality array, the less than register, and the greater than register are input to the optical relational operation processing unit 411, where they are operated upon to produce the relational operation registers 427. The relational operation registers 427 and the match/compare register 421 light plane arrays are routed through the optical output unit 413 that produces the optical output register 429. The optical output register 429 is in the form of a light plane array that represents the solution set of the operations performed by the system. This register may be routed through one or more optical circuits for further processing. This register may also be output to a memory device, a display, or the like, a process which may involve conversion of the light plane array to corresponding electronic signals (e.g., through the use of a sensor array) that are representative of the data contained therein. Alternatively, the device receiving the output may itself be adapted to operate on the light plane array without the conversion of the light plane array into the electronic regime.

The system illustrated in FIG. 9 can utilize several methods for encoding a data plane on a light plane array. For example, binary data patterns can be represented by spatially distributed, orthogonally polarized radiation disposed on a 2-dimensional pixilated grid. This approach for encoding data on a light plane array is described, for example, in A. W. Lohmann, “Polarization and optical logic,” Applied Optics, vol. 25, pp. 1594-1597 (March 1990), which is incorporated herein by reference. In the approach described in this reference, data bits may be represented by the polarization states of electromagnetic radiation. Thus, for example, the logical state of ‘1’ may be represented by a first polarization state of electromagnetic radiation (for example, by vertically polarized radiation), and the logical state of ‘0’ may be represented by a second polarization state of electromagnetic radiation (for example, by horizontally polarized radiation). The presence or absence of electromagnetic radiation within a light plane array, which may be determined, for example, with reference to a predefined intensity threshold, may be used to indicate the selection or deselection of tuples or elements within an array in the system. The individual tuples and/or elements within an array may be differentiated from one another by polarization encoding, with each tuple or element encoded on a unique wavelength or frequency.

Alternatively, in other embodiments of the methods and devices described herein, circularly or elliptically polarized electromagnetic radiation may be employed. In such embodiments, each data bit or tuple may be encoded by the particular characteristics of one of the two polarizations. For example, the logical state of “1” may be defined as the right polarization state of circularly or elliptically polarized electromagnetic radiation, and the logical state of “0” may be defined as the left polarization state of circularly or elliptically polarized electromagnetic radiation. The logical states may also be defined by the relative amplitudes of the polarization states (e.g., when the data or tuples are encoded with elliptically polarized light). Suitable optical elements, such as quarter-wave plates, may be used to produce circularly or elliptically polarized electromagnetic radiation from linearly polarized electromagnetic radiation. The relative phase angles of electromagnetic radiation may also be used to encode logical states.

Moreover, while binary coding is preferred, encoding defined by other solution spaces may also be employed. Thus, for example, encoding schemes based on decimal, hexadecimal, or other such systems may be employed. These later schemes may be based, for example, on the relative phase angles of monochromatic or polychromatic radiation. Thus, for example, a digit k having a value of 0-9 may be encoded by electromagnetic radiation having a phase angle (or range of angles) θₖ. The individual tuples within an array may be differentiated from one another by polarization encoding, with each tuple encoded on a unique wavelength or frequency.

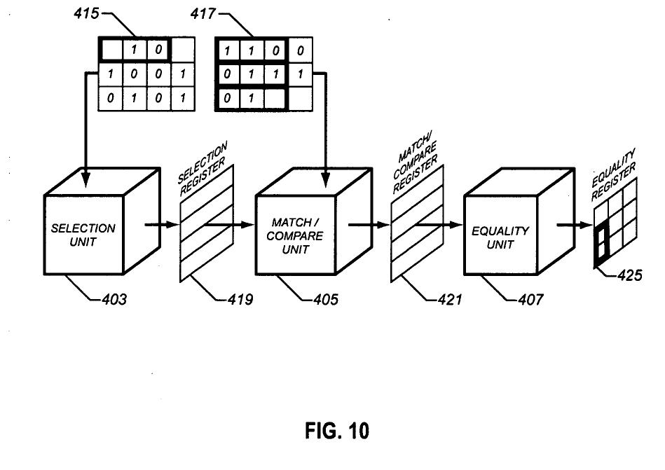

One common operation performed on databases is the equality operation. This operation, which is illustrated in FIG. 10, is performed on the input comparand array 415 and the relational array 417, and is rooted in the XOR concept. The comparand array 415 is the data array that resides in the comparand register, and the relational array 417 is typically the database that occupies the main associative memory of the content addressable memory system. If a word stored in the comparand array 415 matches a word stored in the relational array 417, the resultant word contains only logical ‘0’ bits. Conversely, if there is no word match, the resultant XOR word will be a mixture of logical ‘0’ and logical ‘1’ bits. Consequently, equivalency may be determined through the application of a logical OR function to all of the bits together in the resulting XOR word, such that the words are deemed to be mismatched if the result of applying the OR function to the XOR word is a ‘1’, and the words are deemed to be equivalent if the result of applying the OR function to the XOR word is a ‘0’. The optical equality unit 407 operates in a similar, but more parallel, manner.

The system depicted in FIG. 9 utilizes the optical selection unit 403, the optical match/compare unit 405, and the optical equality unit 407 to test for equivalency. This process is illustrated in FIG. 10 with respect to some exemplary inputs for the comparand array 415 and the relational array 417 and the resulting output equality register 425. In the particular example illustrated, the first three bits of the comparand array tuple “1100” are being compared with the first three bits of each of the tuples in the relational array. Such a search is often referred to as a similarity search in that a subset of the comparand tuple is being compared with some subset of the relational array 417. The description that follows of the optical selection unit 403, the optical match/compare unit 405 and the optical equality unit 407 are based on this example.

The optical Selection Unit 403 is illustrated in FIG. 11. This unit functions to encode a pixilated two-dimensional optical wavefront (or light plane array) with the comparand array 415 that is to be processed such that the rows in the wavefront represent tuples in the comparand array 415. In the particular embodiment depicted, each of these rows or tuples are encoded on a unique wavelength, and the elements of the array are polarization encoded to indicate the particular logical state of each data bit. However, it is to be understood that various other encoding schemes may be employed for the tuples or data bits, some of which have already been mentioned, and that the methodologies and systems described herein are not limited to any particular encoding scheme.

Referring again to FIG. 11, the optical selection unit 403 is equipped with a multiple wavelength source array 431. Each row (which corresponds to a separate tuple) in the source array 431 emits a different wavelength of electromagnetic radiation. In the present example, only a single wavelength is required, so only the first row has been activated. However, it will be appreciated that various logical operations, such as operations involving multiple tuples in the comparand array and the relational array, might require additional wavelengths, and hence activation of multiple rows in the source array 431. Moreover, since only the first three bit positions of the first row are involved in this operation, the element in the last column of the source array 431 has been deactivated. It will be appreciated from the foregoing that the source array 431 acts as a masking register in the content addressable memory.

The generated wavefront is filtered through a horizontally oriented polarizer 433 which resets all of the bit positions or elements of the light plane array 435 to the logical state of ‘0’. The light plane array 435 then impinges on spatial light modulator 437 which polarization encodes the electromagnetic radiation with data from a memory device (in this example, the bit pattern 110). The encoded data may be, for example, a series of binary data bits that have been read from an optical disk and have been encoded with a first polarization state representing the logical state of “0” and a second polarization state representing the logical state of “1”. The resultant selection register 419 is a light plane array that represents the optically encoded version of the comparand array 437.

FIG. 12 illustrates the components and operation of the optical match/compare unit 405. This unit applies an exclusive OR (XOR) function to each element of each tuple in the comparand array 415 (after the comparand array 415 is encoded in the optical selection unit 403 and passed to the optical match/compare unit 405 as the selection register 419) with each tuple in the relational array 417. The optical match/compare unit 405 operates to produce a match/compare register in the form of a light plane array that has a logical ‘1’ at every bit position where there is a mismatch between the comparand array 415 and the relational array 447.

The encoded light plane array (that is, the selection register 419) output by the optical selection unit 403 is passed through a cylindrical lens array 441. The cylindrical lens array 441 spreads each of the rows of the relational array 445 with different wavelengths over the full surface of a spatial light modulator 447. The spatial light modulator 447 encodes the light plane array 445 with the relational array that is to be searched. The spatial light modulator 447 rotates the polarizations of the incident light plane array according to the logic states of its component pixels, thereby generating the result of the XOR operation in the light plane array of the match/compare register 421. This light plane array (referred to herein as the match/compare register 421) contains the bit match and mismatch locations of each of the comparand array 415 and relational array 445 tuple combinations as designated by horizontal and vertical polarizations of electromagnetic radiation, respectively.

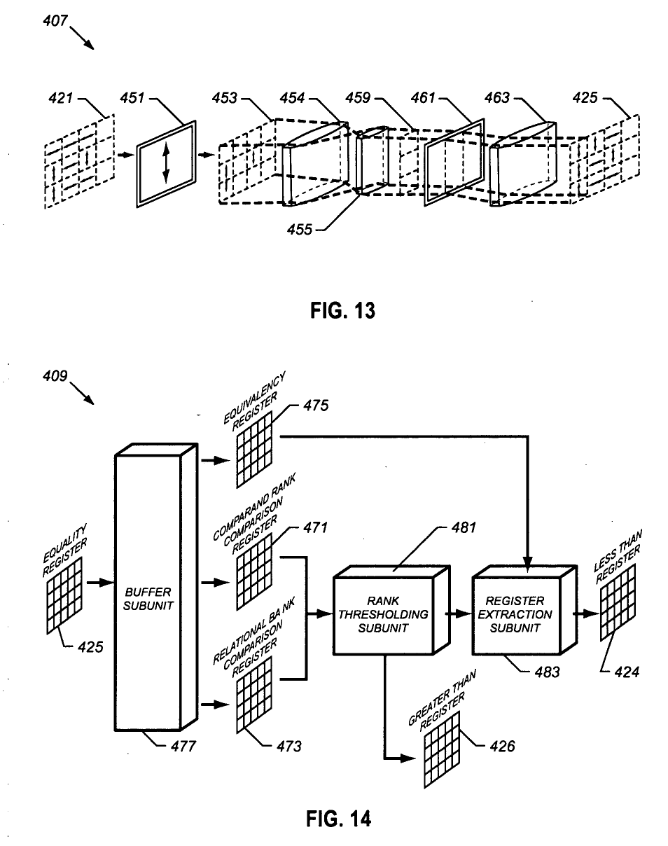

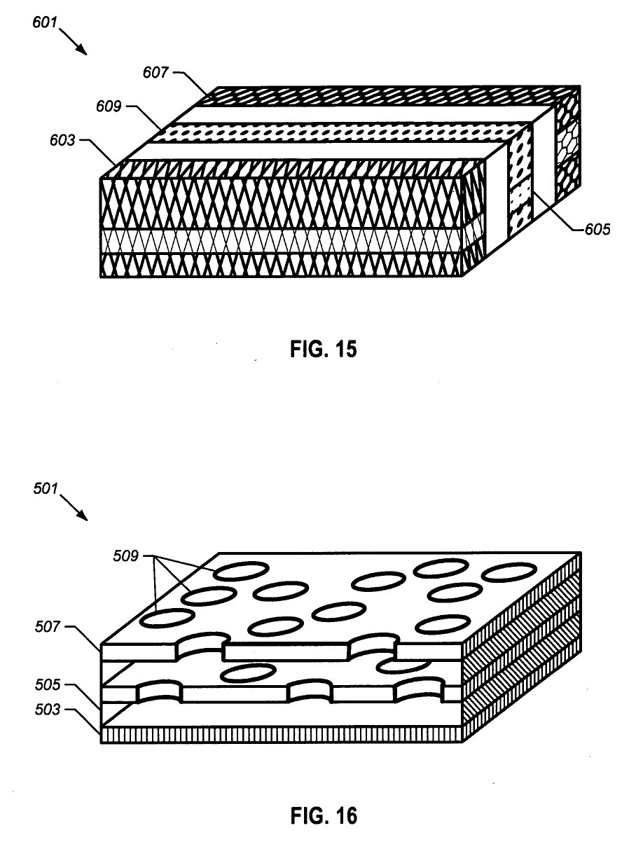

FIG. 13 illustrates the components and functionality of the equality unit 407. This unit identifies matching combinations of comparand array and relational array tuples. The equality unit 407 operates on the match/compare register 421 and converts it to a light plane array (referred to herein as the equality register 425) whose elements represent the equivalency of all of the comparand array 415 and relational array 417 tuple combinations. The equality unit 407 inputs the match/compare register 421 and passes it through a vertically oriented polarizer 451, thereby converting it into a light plane array 453 in which the elements having the rejected polarization have been deleted. The Polarized light Polarizer 451 is selected such that the resulting light plane array 453 contains only illuminated pixels that correspond to each bit mismatch position.

The light plane array 453 is operated upon by cylindrical lenses 455 and 457 which collectively reduce the light plane array 453 to a single column light plane array 459. This single column light plane array 459 is subsequently a wavelength de-multiplexed into a light plane array having a pixel count width equal to the number of tuples in the comparand array. This may be accomplished, for example, through the use of a holographic optical element 461 which is adapted to deflect electromagnetic radiation at an angle that is a function of its wavelength. Cylindrical lens 463 then collimates the light exiting the holographic optical element 461 to produce the light plane array 425 (referred to herein as the equality register). The procedure that is employed for subsequently decoding the equality register 425 is described below.

The light plane array defining the equality register is a two dimensional representation of the intersection of the comparand array 415 and the relational array 417. If the number of tuples in the comparand array 415 is n and the number of tuples in the relational array 417 is m, then the equality register 425 contains a total of m×n pixels or elements. The equality register 425 is encoded such that non-illuminated pixels correspond to exact matches. For an m×n equality register 425, pixel mn is illuminated if the m^{th} tuple of the relational array 417 is not equal to the n^{th} tuple of the comparand array 415.

The system described in FIG. 9 may also be used to implement magnitude comparisons. Operations of this type include “greater than”, “less than”, “in-bound”, “out-of-bound”, and “extremum” operations. The components and functionality of the magnitude comparison unit 409 are depicted in FIG. 14. The magnitude comparison unit 409 inputs the equality register 425 from the equality unit 407 and outputs the less than register 424 and the greater than register 426 (these two registers are referred to collectively herein as less than/greater than registers 423).

The system of FIG. 9 accomplishes the magnitude comparison algorithm through a process that includes the steps of: (1) computing and storing the comparand rank comparison register 471 which compares the comparand array 415 with a rank table; (2) computing and storing the relational rank comparison register 473 which compares the relational array 417 with a rank table; (3) computing and storing the equivalency register 475 which compares the comparand array 415 and relational array 417; (4) computing and outputting the less than register 424 and greater than register 426.

The first three steps of the algorithm are carried out by the optical selection unit 403, the match/compare unit 405 and the equality unit 407, and the results (the equality registers 425) are stored sequentially in the optical buffer subunit 477. The final step of the algorithm requires that these three registers (namely, the equivalency register 475, the comparand rank comparison register 471, and the relational rank comparison register 473) are presented simultaneously to both the rank thresholding subunit 481 and the less than register extraction subunit 483 for final processing.

The optical buffer subunit 477 serves as a temporary storage unit for the equivalency register 475, the comparand rank comparison register 471 and the relational rank comparison register 473. The optical buffer subunit 477 may be implemented as an optoelectronic device (typically a CMOS device) that combines optical inputs and/or outputs with electronic processing circuitry, and is capable of being integrated into two-dimensional arrays. Such a device is known in the art as a “smart pixel array”. In one possible embodiment, the optical buffer subunit 477 consists of three (multiple) polychromatic emitter arrays that are of equal dimensions, and a single detector array whose dimensions are matched to those of the equality register 425.

It will be appreciated that the system described in FIGS. 9-14 may be modified or extended to carry out various other types of logical operations that form the underpinnings of data processing. Moreover, this system is capable of accepting as an input a multidimensional signal generated by a virtual optical head of the type described herein. Hence, this system permits a significant amount of data processing operations to be implemented in the optical regime without the need for an optical/electronic interface disposed between the virtual head and the system that performs logical operations on the signal generated by the virtual head. In addition, the vast degrees of processing freedom associated with electromagnetic radiation can be combined with multiplexing to achieve exceptionally high levels of parallel processing. Hence, when combined with the devices and methodologies described herein for generating and manipulating multidimensional signals, such a system provides unparalleled abilities for processing vast amounts of information at very high speeds.

E. Complex Numbers

The systems and methodologies described herein may make advantageous use of complex numbers based on the generalized number system N+. Complex functions and operators form the core of most signal processing algorithms. However, since complex numbers are two dimensional, they cannot be used in processing signals of more than two dimensions without resorting to iterations performed over sets of complex variables, or by projecting the multidimensional signal onto one or two dimensions. Thus, conventional multivariate signal processing suffers from the limitation that each variable is constrained to represent either one or two-dimensional quantities using the real and complex number systems, respectively. By contrast, complex numbers based on the generalized number system N+ may be of higher dimensions. Thus, for example, a quaternion is a four-dimensional generalization of the complex number system. Quaternions have an imaginary part consisting of three components, and are thus well suited, for example, for operations on three-dimensional color images.

Complex numbers based on the generalized number system N+ in general, and quaternions in particular, may be utilized to generalize techniques from conventional signal and image processing, such as frequency domain filtering and correlation, so that these techniques can be adapted to operate, for example, on vector images. Moreover, various useful complex spectral transformations may be defined to provide extensions to conventional convolution, correlation and transfer functions, including complex Fourier transforms. These definitions may then be utilized to develop linear vector filters that are suitable, for example, in performing color-dependent averaging and color-sensitive edge detection. Hence, the generalized number system N+ provides a means for overcoming the constraints of conventional multivariate signal processing by providing the capability to manipulate complex numbers with user-defined dimension using commutative-associative algebras. Various operators and algorithms based on this number system may be utilized in the devices and methodologies described herein to operate on the multidimensional signals that are generated and utilized in these devices and methodologies.

Complex number theory based on the generalized number system N+ may be used to perform multivariate analysis on multidimensional signals of the type described herein. In a typical application, the signal is encoded with a set of two or more variables that are periodically generated at discrete points in space and/or in time, with each set of the variables originating from multiple (typically three or more) data sources. For example, in an air traffic control application, the variables may relate to the position and velocity of aircraft as a function of time for aircraft that are being monitored by an air traffic control center. In imaging applications, the variables may relate to the intensity of pixels in the blue, green and red portions of the spectrum as a function of spatial location. In airport security applications, the variables may relate to the values of facial recognition or anatomical characteristics as a function of location on a subject's body. The representation of multidimensional signals through the use of complex numbers based on the generalized number system N+ provides a means by which variables that are generated at different points in time or space (or more broadly speaking, variables which are generated at different values of a variable that they depend on) and that originate from diverse data sources may be distinguished from each other.

One of the advantages provided by the application of complex number theory within the generalized number system N+ to the methodologies described herein is that the multivariate analyses thereby enabled generate information on a global level that arises from relationships between the data sources. This global information may then be used to discern patterns of variation that may not be apparent from similar analyses conducted in the real number system. Various mathematical filters and signal processing algorithms may then be developed that utilize this information, possibly in combination with other information known about the system, to achieve particular objectives. These include signal processing techniques that determine such quantities as mean square error.

One particularly advantageous use of complex number theory based on the generalized number system N+ in the application of the principles disclosed herein is in performing multivariate analysis on groups of objects over a given domain (the domain will typically be a time domain, but may also be a frequency or spatial domain). Thus, multidimensional signals of the type described herein may be encoded with data observed during an interval of A sampling periods. Such data may take the form of an A×B matrix of n-dimensional, commutative-associative complex numbers, where A is the number of sampling periods utilized in obtaining the data, n is the number of objects to which the data pertains, and B is the number of variables that are measured for each of the n objects. In this format, each object corresponds to a unique dimension in hyperspace. Since Gauss-Jordan elimination applies to complex numbers, a variety of signal processing techniques that are used with real numbers may be extended to the treatment of complex numbers based on the generalized number system N+ and to operations performed on the aforementioned matrix. However, unlike conventional techniques performed in the real number system, in this approach, distinctions can be made between variables that originate from different objects as well as distinctions between variables that are generated at different points in time. The ability to make these two distinctions allows for the optimization of algorithms that are based on spatial or temporal information combined with patterns of variation that result from relationships that exist between objects.

The advantages of utilizing complex number theory based on the generalized number system N+ in the multivariate analysis of multidimensional signals of the type described herein may be appreciated by considering the shortcomings of multivariate signal processing in the real and complex number systems. In particular, multivariate signal processing based on the real or complex number systems is constrained to represent either one or two-dimensional quantities, respectively. Hence, the algorithms developed for processing multivariate signals from one or two objects, as well as the corresponding performance predictions, do not apply when the number of signal sources is three or greater. Utilization of the generalized number system N+ eliminates this constraint, because it provides the ability to manipulate complex numbers of any desired dimension through the use of commutative-associative algebras.

F. Multilayer Optical Disks

In some embodiments of the devices and methodologies disclosed herein, data may be stored in multilayer optical disks. Each layer in these disks may be encoded with information. The refractive indices of the layers, and the relative thicknesses of the layers, are chosen so that a given pair of layers reflects a specific wavelength, or a specific range of wavelengths, of electromagnetic radiation. Alternatively, the layers may be provided with materials, such as fluorescent dyes, that adsorb or reflect electromagnetic radiation of unique wavelengths or frequencies. Consequently, an appropriately adapted polychromatic radiation source can be used to read information from, or write information to, a given layer, or pair of layers, in the stack. Moreover, multiple layers or pairs of layers, and multiple tracks within a layer or within a pair of layers, may be accessed simultaneously using the methods described herein.

In some embodiments, the data stored in a given layer, or pair of layers, may be polarization encoded with, for example, a first polarization of electromagnetic radiation of wavelength λₙ representing Boolean “0” and a second polarization of electromagnetic radiation of wavelength λₙ representing Boolean “1”.

In other embodiments, data stored in a given layer, or pair of layers, may be color encoded with, for example, electromagnetic radiation of wavelength λₙ representing Boolean “0” and electromagnetic radiation of wavelength λₖ representing Boolean “1”. In some such embodiments, for example, the optical disk may be adapted to reflect one or the other (but not both) of λₙ and λₖ at a given set of spatial coordinates, depending on whether the binary data stored at that location is a Boolean “0” or “1”, respectively. Alternatively, the optical disk may be adapted to reflect either one or both of λₙ and λₖ at a given set of spatial coordinates, depending on whether the binary data stored at that location is a Boolean “0” or “1”, respectively.

It will also be appreciated that the optical disks described herein may use almost any number of layers, or layer pairs, to store data, and that the data may be stored using virtually any number system (e.g., decimal, hexadecimal, etc.). For example, if the data is encoded using a number system having k basis vectors, the optical disk may be provided with layer pairs n₁, . . . , nₖ that are adapted to reflect one or more of wavelengths λₙ₁, . . . , λₙₖ (or polarizations of those wavelengths) of electromagnetic radiation at a given set of spatial coordinates, depending on the numerical value of the data stored at that location. Hence, for example, k may be 10 in the case of decimal data, or 16 in the case of hexadecimal data. By way of illustration, the word [10011010] could be encoded such that wavelengths λ₁, λ₄, λ₅, and λ₇ are reflected at a given set of spatial coordinates.

It will further be appreciated that the multilayer optical disks described herein may use other forms of radiation besides linearly polarized or unpolarized radiation, and may use other characteristics of that radiation to encode data. For example, in some embodiments, circularly or elliptically polarized electromagnetic radiation may be employed, and the optical disk may be adapted to modify one or more characteristics of the electromagnetic radiation impingent thereon in accordance with the data encoded on the disk. Thus, for example, encoding schemes based on the relative phase angles of monochromatic or polychromatic radiation may be employed, and the individual layers, or layer pairs, in the optical disk may be adapted to manipulate the phase angle of incident radiation so as to encode it with the data stored on the disk.

As one non-limiting example of a multilayer optical disk that may be used in the systems and methodologies described herein, a multilayer disk is provided which has layers Lᵢ, where i=1 top. A fluorescent material mᵢ is provided in each layer Lᵢ of the disk. Preferably, for i, jε(1, . . . , p), when i≠j, material mᵢ reflects a different wavelength of light than material mⱼ (that is, materials mᵢ and mⱼ are optically distinct). It is thus possible to direct electromagnetic radiation through the disc and to read the proper wavelength for the expected layer. Consequently, through the use of this technology, optical disks (or media having various other shapes) can be made which have virtually any desired number of layers, and these layers may be read separately or in parallel using the methodologies described herein.

One non-limiting example of such a multilayer optical memory device is depicted in FIG. 16. The device 501 depicted therein comprises a substrate 503 in the form of a plastic or glass disk. The substrate supports a stack of alternating layers of a transparent, non-fluorescent optical material 505 and an information carrying material 507 in which data may be encoded. In the particular embodiment depicted, the data is encoded in the form of cells 509 that are distributed as “pits” arranged in rows along concentric circles or spirals. These circles or spirals define a series of tracks within the layers of information carrying material 507.

The information carrying material 507 may be a mixture of a fluorescent dye, a solvent, a host material and a photosensitive component. The fluorescent dye is preferably capable of existing in one of two isomeric forms, only one of which is fluorescent, and may be made to assume the fluorescent isomer upon illumination with a source of actinic radiation. Possible fluorescent dyes that may be used for this purpose include, for example, Carbazine 122, Pyridin 1, Nile Blue, DQOCI, Rhodamine 6G, Rhodamine 800, DCI-2, Styryl 6, Oxazine 750, DTDCI, Phenoxazon 9, or mixtures of the foregoing. These dyes are suitable for excitation with 630-650 nm laser diodes. It will be appreciated, however, that other fluorescent dyes may be used in conjunction with laser diodes that are adapted for excitation at other wavelengths. Preferably, the fluorescent dyes used in each of the layers of information carrying material 507 fluoresce at different wavelengths or frequencies of electromagnetic radiation, thus allowing these layers to be read from or written to without affecting the remaining layers.

The layer of transparent, non-fluorescent optical material 505 comprises a high quality optical material, and typically has a thickness within the range of about 10 to about 50 μm, and more preferably within the range of about 15 to about 30 μm. Materials for this layer may include, but are not limited to, optical grade polymers based on polycarbonate, polyimide, silicone adhesive, UV adhesive, or lacquers. Specific examples of such materials include MACROLON™ CD 2005/MAS130, MACROLON™ DP 1-1265, and MACROFOL™ DE 1-1 optical polymers available commercially from Bayer AG, DURAMID™ optical polymers available commercially from Rogers Corp., ULTEM™ optical polymers, available commercially from GE Plastics, and AI-10™ optical polymers, available commercially from Amoco, Inc.

It will be appreciated that the devices and methodologies disclosed herein provide a unique means for harnessing the full power of multilayer optical disks. In particular, these devices and methodologies transform multilayer optical disks from a medium which is merely capable of storing large amounts of information in a compact form to a medium that can be used to provide virtually instantaneous access to large amounts of information through simultaneous access of multiple tracks in multiple layers of the disk.

G. Security Applications

It is important to note that the binary signal constructed from said technology offers many advantageous to current sequential, binary signals. Specifically, binary data is constructed in multiple dimensions within a single signal. One advantage to such construction of a signal in multiple dimensions compared to a current linear binary signal is multiple bit streams embedded within a single signal. One skilled in the art can appreciate that such a multidimensional signal has significant impact in encryption & processing, networking, and telecommunications.

The methods and devices described herein have numerous applications. One specific application that is particularly suitable for the implementation of these devices and methodologies is security. For example, attempts to track terrorists, criminals or other subjects of interest at airports, train stations, subways, sports arenas, gambling casinos or other public places, is often thwarted by lack of timely information. In particular, even if a subject of interest is selected for identification, the identification process itself may take too long to generate actionable information. Also, the process is often complicated by incomplete information, because the subject of interest may not be present on a database to which the surveillance system has access. Access to multiple databases is a potential solution; however, different databases store information in different formats, and the translation between formats may be too complicated or time consuming to yield actionable information.

The methodologies disclosed herein can facilitate this process on several fronts. First of all, these methodologies (and the devices which implement them) allow a surveillance system to process large amounts of data almost instantaneously, both due to the parallel processing abilities inherent in these methodologies (e.g., the ability to read multiple tracks on an optical data storage medium simultaneously) and due to the ability to operate on the multidimensional signals generated by these methodologies in the optical regime. Hence, these methodologies produce results in a timely enough manner to be actionable. Moreover, the methodologies disclosed herein allow for easy sharing of files between diverse databases, due to the ability to use multidimensional principals for translating between file types.

As a result of the foregoing, surveillance systems can be assembled in which signals generated by one or more cameras or other surveillance devices that are located in airports, train stations, buildings, or other sites to be secured, can be compared with signals generated by various databases maintained by various governments or security agencies. The later signals may be combined, if desired, into a master signal through the suitable use of multiplexing. These signals may be encoded with data relating to various anatomical features to permit facial recognition or other such security operations, and various logical operations may be performed on these signals. Such logical operations may be performed, for example, in the optical regime, which allows vast amounts of information to be processed almost instantaneously. This process may be further facilitated through the utilization of complex operators to operate on these multidimensional signals. Such operators could be used, for example, to ascertain anatomical features through image analysis, or to adjust for aging, alterations in appearance, or changes in lighting. Hence, such systems have the ability to process vast amounts of information from diverse databases in a short enough time to yield actionable results.

H. Lenses

Various lenses and lens arrays can be used in the devices and methodologies disclosed herein. These lenses may consist of a single element or of a plurality of elements. As an example of the later, lenslet arrays may be used advantageously in the devices and methodologies described herein. The lens used have flat or contoured surfaces or combinations of the two, and can also have various shapes. The lenses can be arranged in parallel, in a staggered formation, in an offset formation, in an off-axis formation, or various combinations and subcombinations of the foregoing. In some embodiments, the lenses may be used with optical fibers mounted on the backs of the lenses. The components of the lens array, or the array as a whole, can be mounted statically or on a movable assembly.

Methodologies and devices have been disclosed herein that eliminate or significantly reduce seek time, lower the overall costs of production and maintenance, and structure data in a real world, three dimensional matrix that results in the ability to perform complex mathematical computations that are impossible with today's one dimensional technology. The time to retrieve any amount of data is irrelevant to the amount of data to be retrieved. Moreover, these methodologies and devices provide superior parallel performance, superior data management systems and software performance, greater bandwidth, higher data transfer rates, and elimination or near elimination of input/output bottlenecks.

Although the description above contains many specificities, these should not be construed as limiting the scope of the invention, but as merely providing illustrations of some of the presently preferred embodiments of this invention. Various other embodiments and ramifications are possible within the scope of the present disclosure.

For example, the superior and more efficient means provided herein for storing, retrieving, processing and transmitting data will result in advances in medicine, scientific research and engineering. It is also evident that the devices and methodologies disclosed herein can result in substantial increases in performance in the storage, retrieval, processing and transmission of data, while also reducing long term overall costs, thus resulting in overall increases in bandwidth and lower costs. Consequently, it will be appreciated that the devices and methodologies disclosed herein will result in substantial improvements in telecommunications and networking functionality, encryption and data processing, etc.

It will also be appreciated that, while the devices and methodologies disclosed herein have frequently been described with reference to specific components (e.g., linear detector arrays, CMOS or CCD photo diode arrays, etc.), these components may be replaced by other components of like functionality that are presently available or that become available in the future.

What is claimed is: A. Data Processing in Optical Regime with MD Signal

1. A device for retrieving data from a data storage medium, comprising:
a source of electromagnetic radiation;
an optical data processing system adapted to perform logical operations in the optical regime on an input multidimensional optical signal; and
an optical device adapted to direct electromagnetic radiation onto the surface of a data storage medium and to input reflections of the electromagnetic radiation, in the form of a multidimensional optical signal, to said optical data processing system.

2. The device of claim 1, wherein said optical data processing system is adapted to transform said input multidimensional optical signal into a first optical data array which is encoded with at least a first and second wavelength of electromagnetic radiation.

3. The device of claim 2, wherein said source of electromagnetic radiation emits said first and second wavelengths of electromagnetic radiation.

4. The device of claim 2, wherein said optical data array is encoded with first and second polarizations of each of said first and second wavelengths of electromagnetic radiation.

5. The device of claim 2, wherein said logical operations include comparing the first optical data array with a second optical data array.

6. The device of claim 5, wherein the comparison is a magnitude comparison between the first and second optical data arrays.

7. The device of claim 5, wherein the comparison is an equality comparison between the first and second optical data arrays.

8. The device of claim 2, wherein said optical data array is a two-dimensional array.

9. The device of claim 1, wherein said optical device comprises a holographic lens element and a mirror, and wherein said holographic lens element is adapted to cooperate with said mirror so as to generate a hologram in the form of a multidimensional data pattern.

10. The device of claim 9, wherein said holographic lens element is adapted to cooperate with said mirror so as to generate a multidimensional signal that is input into said optical data processing system.

11. The device of claim 9, wherein the holographic lens element is adapted to receive electromagnetic radiation reflected from the data storage medium and is further adapted to generate, from the reflected electromagnetic radiation, a hologram in the form of a multidimensional data pattern that is input into said optical data processing system.

12. The device of claim 1, wherein said source of electromagnetic radiation is a laser source.

13. The device of claim 1, wherein the holographic lens element is adapted to receive electromagnetic radiation from said electromagnetic radiation source and is further adapted to generate, from the electromagnetic radiation, a hologram in the form of a multidimensional data pattern that is input into said optical data processing system.

14. The device of claim 1, wherein said multidimensional data pattern comprises a plurality of line patterns.

15. The device of claim 1, wherein said data storage medium comprises a plurality of tracks, and wherein said multidimensional data pattern comprises a plurality of line patterns, each of which corresponds to electromagnetic radiation reflected from one of said plurality of tracks.

16. The device of claim 15, wherein said data storage medium is an optical disk.

17. The device of claim 1, wherein said holographic lens element comprises a beam splitter.

18. The device of claim 1, wherein said mirror is a one-way mirror.

19. The device of claim 1, wherein said source of electromagnetic radiation is a monochromatic laser source.

20. The device of claim 1, wherein said source of electromagnetic radiation is a polychromatic laser source.

21. The device of claim 9, wherein said holographic lens element is a sinusoidal line generating diffraction grating holographic lens element.

22. The device of claim 9, wherein said holographic lens element is a binary phase beam splitting diffraction grating holographic lens element.

23. The device of claim 1, wherein the data storage medium is an optical disk having at least first and second layers therein for storing data, wherein said source of electromagnetic radiation emits at least first and second wavelengths of electromagnetic radiation, wherein said first wavelength is utilized to read data from said first layer, and wherein said second wavelength is used to read data from said second layer.

101. A device, comprising:
a source of electromagnetic radiation;
a first reflective element adapted to direct the electromagnetic radiation onto the surface of a data storage device;
a second element adapted to capture binary data in multiple dimensions from the data storage device in the form of a multidimensional signal; and
an optical data processing system adapted to perform logical operations on the multidimensional signal in the optical regime.

201. A device, comprising:
a source of an electromagnetic radiation signal;
a first reflective element adapted to direct the electromagnetic radiation signal onto the surface of a data storage device;
a second element adapted to capture binary data in multiple dimensions from the data storage device; and
an optical data processing system adapted to perform logical operations on the captured binary data in the optical regime.

202. The device of claim 201, wherein the data storage device is a static storage medium.

203. The device of claim 201, wherein said signal can be measured dimensionally by a function of binary data.

204. The device of claim 201, wherein said signal can be measured dimensionally by a function of binary bits in relation to time.

205. The device of claim 201, wherein said signal comprises, and can be measured by, some function of binary bits in relation to space.

206. The device of claim 201, wherein said signal comprises, and can be measured by, any given number of bits of information in relation to combinations of space and time.

207. The device of claim 206, wherein said signal can be processed mathematically with at least one algorithm selected from the group consisting of linear, non-linear, parallel, and multidimensional algorithms.
B. Use of Multilayer Disk with MD Signal

401. A device, comprising:
a source of electromagnetic radiation;
a multilayer data storage device having at least first and second layers in which data is stored;
a first optical element adapted to direct electromagnetic radiation emitted by the source of electromagnetic radiation onto the surfaces of said first and second layers; and
a second optical element adapted to transform reflections of the electromagnetic radiation from said first and second layers into a multidimensional optical signal.

402. The device of claim 401, wherein said multidimensional optical signal is encoded with data from said first and second layers.

403. The device of claim 401, wherein each of said first and second layers has a plurality of tracks thereon in which data is stored, and wherein said multidimensional optical signal is encoded with data from a plurality of the tracks on said first layer and a plurality of the tracks on said second layer.

404. The device of claim 401, wherein said second optical element is further adapted to capture reflections of the electromagnetic radiation from said first and second layers.

405. The device of claim 401, wherein said multilayer data storage device is a multilayer optical disk.

406. The device of claim 401, wherein said source of electromagnetic radiation emits first and second wavelengths of electromagnetic radiation, and wherein the device is adapted to utilize the first wavelength of electromagnetic radiation to read data stored in the first layer of the multilayer data storage device and to utilize the second wavelength of electromagnetic radiation to read data stored in the second layer of the multilayer data storage device.

407. The device of claim 401, wherein the first and second layers of the multilayer data storage device are provided with first and second fluorescent dyes, respectively.

408. The device of claim 406, wherein the first and second layers of the multilayer data storage device are provided with first and second fluorescent dyes, respectively, and wherein the first fluorescent dye adsorbs the first wavelength of electromagnetic radiation and the second fluorescent dye adsorbs the second wavelength of electromagnetic radiation.

409. The device of claim 406, wherein the first and second layers of the multilayer data storage device are provided with first and second fluorescent dyes, respectively, and wherein the first fluorescent dye reflects the first wavelength of electromagnetic radiation and the second fluorescent dye reflects the second wavelength of electromagnetic radiation.

410. The device of claim 406, wherein the first and second layers of the multilayer data storage device are provided with first and second dyes, respectively, and wherein the first dye undergoes a transition from a first non-fluorescent isomeric form to a second fluorescent isomeric form upon exposure to the first wavelength of electromagnetic radiation.

411. The device of claim 410, wherein the first dye does not undergo a transition from the isomeric form to the second isomeric form upon exposure to the second wavelength of electromagnetic radiation.

412. The device of claim 401, wherein the data stored in the first and second layers of the multilayer data storage device is polarization encoded.

413. The device of claim 412, wherein the data stored in the first and second layers of the multilayer data storage device is polarization encoded such that Boolean 0 is represented by a first polarization of electromagnetic radiation and Boolean 1 is represented by a second polarization of electromagnetic radiation.

414. The device of claim 401, wherein the first and second layers of the multilayer data storage device have first and second refractive indices along an axis perpendicular to the major surfaces of the layers for a first wavelength of electromagnetic radiation emitted by said source of electromagnetic radiation.

415. The device of claim 401, wherein the data stored in the first and second layers of the multilayer data storage device is encoded by the effect it has on the phase angle of actinic radiation.

416. The device of claim 401, wherein the device is adapted to utilize electromagnetic radiation emitted by the source of electromagnetic radiation as actinic electromagnetic radiation to read the data stored in the first and second layers, and wherein the first and second layers are separated by a third layer that is transparent to the actinic radiation.

417. The device of claim 416, wherein the first, second and third layers are joined in a cohesive mass.

501. A method for device, comprising:
providing a source of electromagnetic radiation;
providing a multilayer data storage device having at least first and second layers in which data is stored;
directing the electromagnetic radiation onto the surfaces of said first and second layers; and
transforming the reflections of the electromagnetic radiation from the first and second layers into a multidimensional optical signal.

502. The method of claim 501, wherein said multidimensional optical signal is encoded with data from said first and second layers.

503. The method of claim 501, wherein each of said first and second layers has a plurality of tracks thereon in which data is stored, and wherein said multidimensional optical signal is encoded with data from a plurality of the tracks on said first layer and a plurality of the tracks on said second layer.

504. The method of claim 501, further comprising the step of:
capturing reflections of the electromagnetic radiation from said first and second layers.

505. The method of claim 501, wherein the multilayer data storage device is a multilayer optical disk.

506. The method of claim 501, wherein the source of electromagnetic radiation emits first and second wavelengths of electromagnetic radiation, and further comprising the steps of:
utilizing the first wavelength of electromagnetic radiation to read data stored in the first layer of the multilayer data storage device; and
utilizing the second wavelength of electromagnetic radiation to read data stored in the second layer of the multilayer data storage device.

507. The method of claim 501, wherein the first and second layers of the multilayer data storage device are provided with first and second fluorescent dyes, respectively.

508. The method of claim 506, wherein the first and second layers of the multilayer data storage device are provided with first and second fluorescent dyes, respectively, and wherein the first fluorescent dye adsorbs the first wavelength of electromagnetic radiation and the second fluorescent dye adsorbs the second wavelength of electromagnetic radiation.

509. The method of claim 506, wherein the first and second layers of the multilayer data storage device are provided with first and second fluorescent dyes, respectively, and wherein the first fluorescent dye reflects the first wavelength of electromagnetic radiation and the second fluorescent dye reflects the second wavelength of electromagnetic radiation.

510. The method of claim 506, wherein the first and second layers of the multilayer data storage device are provided with first and second dyes, respectively, and wherein the first dye undergoes a transition from a first non-fluorescent isomeric form to a second fluorescent isomeric form upon exposure to the first wavelength of electromagnetic radiation.

511. The method of claim 510, wherein the first dye does not undergo a transition from the isomeric form to the second isomeric form upon exposure to the second wavelength of electromagnetic radiation.

512. The method of claim 501, wherein the data stored in the first and second layers of the multilayer data storage device is polarization encoded.

513. The method of claim 512, wherein the data stored in the first and second layers of the multilayer data storage device is polarization encoded such that Boolean 0 is represented by a first polarization of electromagnetic radiation and Boolean 1 is represented by a second polarization of electromagnetic radiation.

514. The method of claim 501, wherein the first and second layers of the multilayer data storage device have first and second refractive indices along an axis perpendicular to the major surfaces of the layers for a first wavelength of electromagnetic radiation emitted by said source of electromagnetic radiation.

515. The method of claim 501, wherein the data stored in the first and second layers of the multilayer data storage device is encoded by the effect it has on the phase angle of actinic radiation.

516. The method of claim 501, further comprising the step of
utilizing electromagnetic radiation emitted by the source of electromagnetic radiation as actinic electromagnetic radiation to read the data stored in the first and second layers;
wherein the first and second layers are separated by a third layer that is transparent to the actinic radiation.

517. The method of claim 516, wherein the first, second and third layers are joined in a cohesive mass.

518. The method of claim 501, further comprising the step of:
capturing the reflections of the electromagnetic radiation from the first and second layers.
C. Application of Complex Algorithms to MD Signal

601. A method for performing signal processing, comprising:
providing a first source of electromagnetic radiation;
directing the electromagnetic radiation onto the surface of a first optical data storage medium;
converting the reflections from the optical data storage medium into a first multidimensional signal that is encoded with data stored in the optical data storage medium; and
operating on the first multidimensional signal using a complex operator based on the generalized number system N+ and having at least three dimensions.

602. The method of claim 601, wherein said complex operator is a Fourier transform.

603. The method of claim 601, wherein said complex operator is an optical filter.

604. The method of claim 603, wherein said first multidimensional signal is encoded with image data stored in the first optical storage medium.

605. The method of claim 604, further comprising the steps of:
receiving a second multidimensional signal which is encoded with image data stored in a second optical storage medium;
combining the first and second multidimensional signals into a third multidimensional signal; and
operating on the third multidimensional signal using a complex operator.

606. The method of claim 605, wherein said first optical data storage medium is located remotely from said second optical data storage medium.

607. The method of claim 604, further comprising the steps of:
receiving a second multidimensional signal which is encoded with image data stored in a second optical storage medium; and
operating on the first and second multidimensional signals using a complex operator.

608. The method of claim 601, wherein the complex operator is a quaternion operator.

609. The method of claim 601, wherein the first multidimensional signal is encoded with a set of at least first and second variables that are periodically generated at discrete points in at least one domain.

610. The method of claim 609, wherein the at least one domain is selected from the group consisting of space and time.

611. The method of claim 609, wherein each set of the first and second variables originates from n data sources, wherein n≧3.

612. The method of claim 609, wherein the first and second variables are periodically generated at discrete points in space and time.

613. The method of claim 601, wherein the first multidimensional signal is encoded with data observed during an interval of A sampling periods from n data sources, wherein n≧3.

614. The method of claim 613, wherein A≧2.

615. The method of claim 613, wherein the data is in the form of an A×B matrix of n-dimensional complex numbers.

616. The method of claim 615, wherein said complex numbers are commutative-associative complex numbers.
D. Security Applications

701. A method for identifying an individual, comprising:
obtaining a first multidimensional signal from a first source, said first signal being encoded with image data relating to the anatomical features of individuals whose images are stored in a first database;
obtaining a second multidimensional signal from a second source, said second signal being encoded with image data relating to the anatomical features of individuals whose images are stored in a second database;
obtaining a third signal from a third source, said third signal being encoded with the anatomical features of an individual whose identity is to be ascertained; and
comparing the data encoded in the third signal to the data encoded in the first and second signals.

702. The method of claim 701, wherein the step of comparing the data encoded in the third signal to the data encoded in the first and second signals involves the step of performing multivariate analysis on the first and second signals.

703. The method of claim 702, wherein the multivariate analysis involves operating on at least one of the first and second signals with a complex operator.

704. The method of claim 703, wherein the multivariate analysis is conducted in the optical regime.

705. The method of claim 701, wherein the anatomical features comprise a plurality of facial features.

706. The method of claim 701, wherein said third signal is generated by a security camera.

707. The method of claim 706, wherein the security camera is located in an airport.

708. The method of claim 706, wherein said first and second databases are located remotely from each other.

709. The method of claim 701, wherein the step of comparing the data encoded in the third signal to the data encoded in the first and second signals includes the steps of:
converting the first, second and third signals into first, second and third light planes, respectively, each of said light planes comprising a two-dimensional data array; and
performing logical operations on the light planes in the optical regime.

710. The method of claim 709, wherein the logical operations involve comparing a tuple of the third light plane to a tuple of at least one of the first and second light planes.

801. A signal composed and constructed:
of binary data in multiple dimensions greater than two;
a signal which comprises of multiple bit streams within a single signal.

801. A signal comprising binary data in more than two dimensions and comprising multiple bit streams within the signal.
